(19) United States
(12) Patent Application Publication
(10) Pub. No.: US 2008/0253116 A1
(43) Pub. Date: Oct. 16, 2008

(54) Lamp Structure

(76) Inventor: Yung-Chiang Liao, Taipei City (TW)

Correspondence Address: HDSL, 4331 STEVENS BATTLE LANE, FAIRFAX, VA, 22033, US

(21) Appl. No.: 11/735,653

(22) Filed: Apr. 16, 2007

(51) Int. Cl. F21V 29/00

(52) U.S. Cl. 362/235

(57) ABSTRACT

A lamp structure includes an electrical unit and a shade unit. The electrical unit is formed in a radiation shape or a spiral, triangular or rectangular shape and is fitted with a plurality of light emitting elements. The electrical unit is connected with the shade unit. Because the electrical unit and the shade unit have the same shape, the lamp structure is easy to assemble. Because the light emitting elements are placed on the electrical unit in an evenly distributed manner, the light generated from the light emitting elements may be evenly distributed to the ambient surrounding.

### BACKGROUND OF THE INVENTION

1. Field of the Invention

The invention generally relates to an improved lamp structure. More particularly, the invention relates to an improved lamp structure that is easy to assemble and enables light to be evenly distributed to the ambient surrounding.

2. Description of the Prior Art

Hanging lamps, desk lamps and wall lamps have been widely used in our homes for illumination or to create a present atmosphere. However, the lamps of the prior art have the following disadvantages:

1. Most of the lamps of the prior art use incandescent bulbs, mercury lights, sodium lights, etc.; therefore, they have a relatively lower efficiency in terms of the energy conversion from electricity to light and consume relatively more power.

2. In the lamps of the prior art, light can not be evenly distributed; it is projected in a certain direction.

3. The lamps of the prior art do not have an appealing structure.

Therefore, we can see that the lamps of the prior art have many disadvantages and need to be improved.

To eliminate the disadvantages of the prior art, the inventor has put in a lot of effort in the subject and has successfully come up with the improved lamp structure of the present invention.

### SUMMARY OF THE INVENTION

The present invention is to provide an improved lamp structure in which the electrical unit is formed in a radiation shape or a spiral, triangular or rectangular shape and the shade unit has the same shape so that the improved lamp structure of the present invention is easy to assemble and the light generated by the light emitting elements may be evenly distributed to the ambient surrounding.

The improved lamp structure of the present invention comprises an electrical unit and a shade unit. The electrical unit is formed in a radiation shape or a spiral, triangular or rectangular shape and is fitted with a plurality of light emitting elements. The shade unit is also formed and has the same shape. The electrical unit is connected with the shade unit. Because the electrical unit and the shade unit have the same shape, the improved lamp structure of the present invention is easy to assemble. Because the light emitting elements are placed on the electrical unit in an evenly distributed manner, the light generated from the light emitting elements may be evenly distributed to the ambient surrounding.

These features and advantages of the present invention will be fully understood and appreciated from the following detailed description of the accompanying Drawings.

### BRIEF DESCRIPTION OF THE DRAWINGS

FIG. 1 is a perspective view showing an electrical unit and a shade unit according to the present invention.

FIG. 2 is a perspective view showing how the electrical unit and the shade unit connected together.

FIG. 3 is a perspective view showing another embodiment of the improved lamp structure of the present invention.

FIG. 4 is a perspective view showing a third embodiment of the improved lamp structure of the present invention.

FIG. 5 is a perspective view showing a fourth embodiment of the improved lamp structure of the present invention.

FIGS. 6A and 6B are two perspective views illustrating how the improved lamp structure of the present invention is used for a desk lamp.

### DETAILED DESCRIPTION OF THE PREFERRED EMBODIMENT

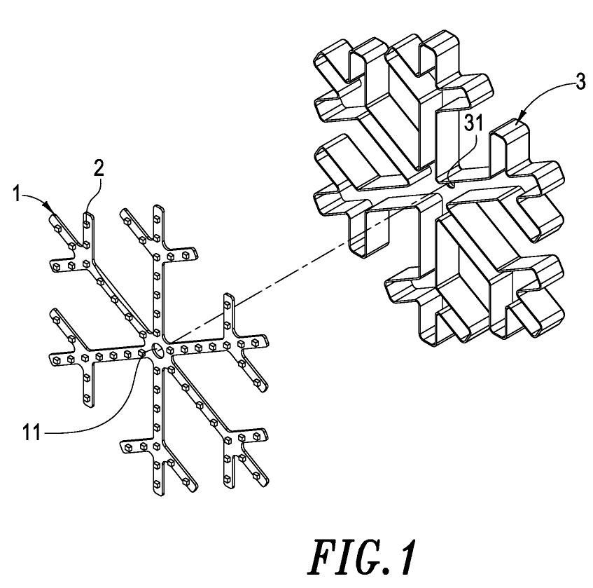

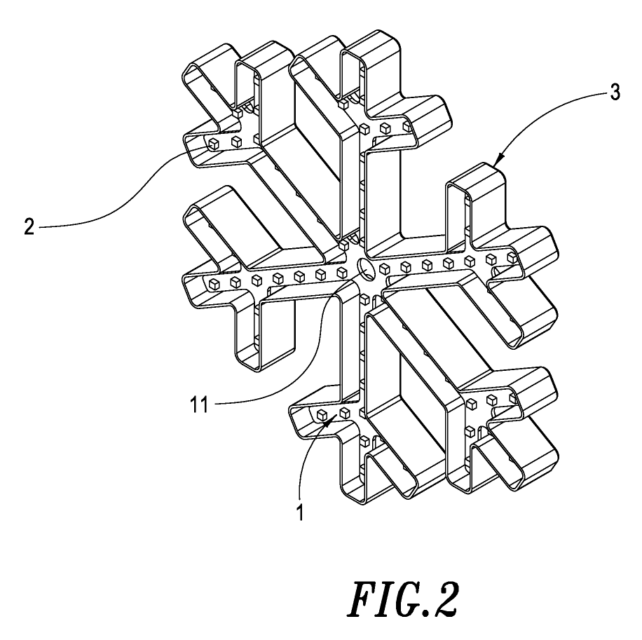

Please see FIGS. 1 and 2. The improved lamp structure of the present invention comprises an electrical unit 1 and a shade unit 3.

The electrical unit 1 is formed in a radiation shape. A hole 11 is centrally provided in the electrical unit 1. A plurality of light emitting elements 2 are fitted on the electrical unit 1. These light emitting elements 2 may be LED.

The shade unit 3 is formed in the same shape. A hole 31 is centrally provided in the shade unit 3.

The electrical unit 1 is connected with the shade unit 3 through the holes 11 and 31. Also, the electrical unit 1 is connected with the shade unit 3 by a fastener or other means (not shown in the drawings).

The shade unit 3 may be made of a heat dissipating material. After the electrical unit 1 is connected with the shade unit 3, the shade unit 3 may act as a heat dissipating unit; in other words, heat generated by the light emitting elements 2 may be swiftly dissipated. Therefore, the goal of fast heat dissipation may be reached and the light emitting elements 2 may have a longer service life.

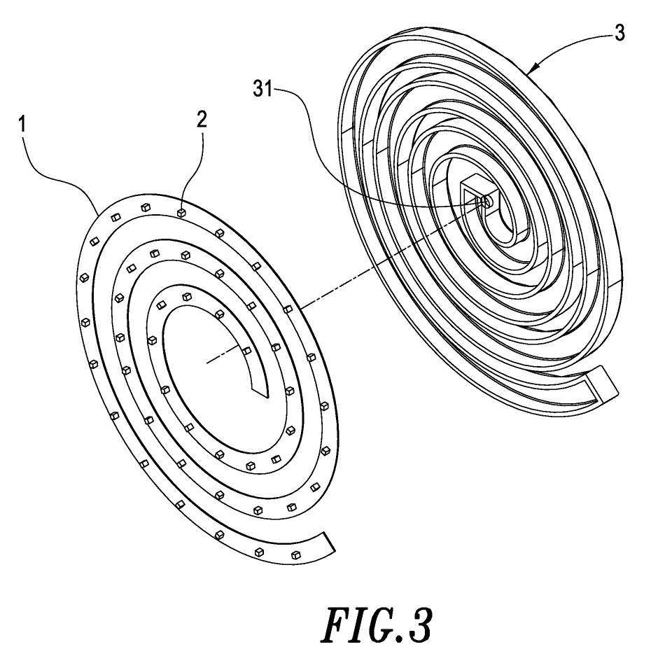

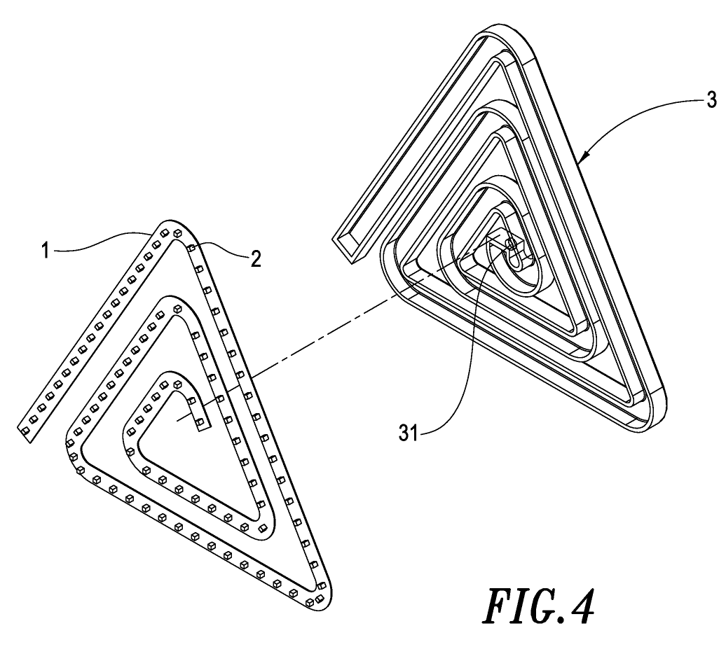

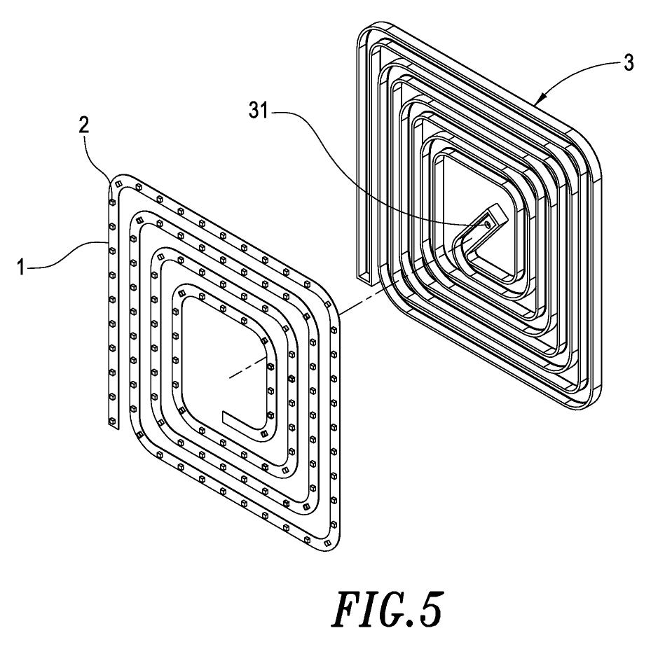

FIGS. 3 to 5 illustrate other three embodiments of the improved lamp structure of the present invention. In FIG. 3, both the electrical unit 1 and the shade unit 3 have a spiral shape. In FIG. 4, both the electrical unit 1 and the shade unit 3 have a triangular shape. In FIG. 5, both the electrical unit 1 and the shade unit 3 have a rectangular shape. In addition, both the electrical unit 1 and the shade unit 3 may have other shapes.

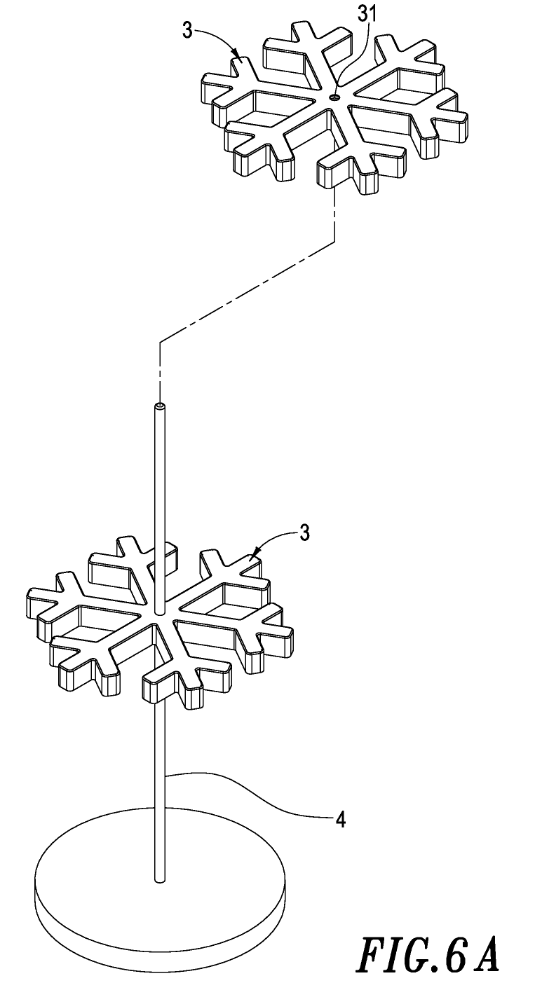

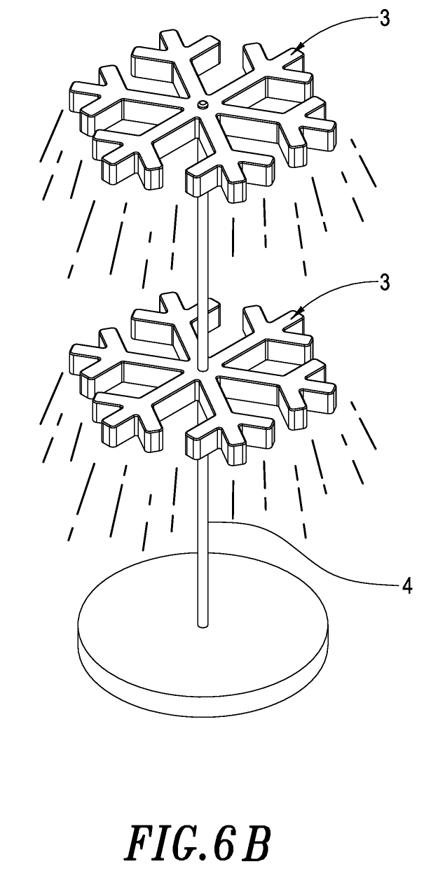

FIGS. 6A and 6B illustrate how the improved lamp structure of the present invention is used for a desk lamp. The vertical rod 4 of a desk lamp is inserted into the holes 11 and 31 so as to connect the electrical unit 1 and the shade unit 3 with the rod 4. After the electrical unit 1 and the shade unit 3 is connected with the rod 4, the light emitted from the light emitting elements 2 may be evenly distributed to the ambient surrounding.

In comparison to the lamp structures of the prior art, the improved lamp structure of the present invention has the following three advantages:

1. Because the electrical unit and the shade unit have the same shape, the improved lamp structure of the present invention is easy to assemble.

2. Because the light emitting elements are placed on the electrical unit in an evenly distributed manner, the light generated from the light emitting elements may be evenly distributed to the ambient surrounding.

3. With the special shape and appealing appearance, the improved lamp structure of the present invention may motivate the consuming public to buy it.

Although several embodiments of the present invention have been described in detail hereinabove, it should be understood that the embodiments are to be regarded in an illustrative manner rather than a restrictive manner, and all variations and modifications of the basic inventive concepts herein taught still fall within the scope of the present invention.

From the above, we can see that the improved lamp structure of the present invention meets the relevant patent requirements. It is hoped that the patent application will be approved.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A lamp structure, comprising:
an electrical unit, formed in a radiation shape and fitted with a plurality of light emitting elements; and
a shade unit having the same shape as the electrical unit,
wherein the electrical unit is connected with the shade unit and the light emitting elements are evenly distributed on the shade unit.

2. The lamp structure as in claim 1, wherein a hole is centrally provided in the electrical unit and a hole is centrally provided in the shade unit, and the holes allow the lamp structure to be connected with a vertical rod of a lamp.

3. The lamp structure as in claim 1, wherein the light emitting elements are LEDs.

4. The lamp structure as in claim 1, wherein the electrical unit is connected with the shade unit by a fastener.

5. The lamp structure as in claim 1, wherein the shade unit is made of a heat dissipating material and, after the electrical unit is connected with the shade unit, the shade unit acts as a heat dissipating unit.

6. A lamp structure, comprising:
an electrical unit, formed in a spiral, triangular or rectangular shape and fitted with a plurality of light emitting elements; and
a shade unit having the same shape with the electrical unit,
wherein the electrical unit is connected with the shade unit and the light emitting elements are evenly distributed on the shade unit.

7. The lamp structure as in claim 6, wherein a hole is centrally provided in the electrical unit and a hole is centrally provided in the shade unit, the holes allow the lamp structure to be connected with a vertical rod of a lamp.

8. The lamp structure as in claim 6, wherein the light emitting elements are LEDs.

9. The lamp structure as in claim 6, wherein the electrical unit is connected with the shade unit by a fastener.

10. The lamp structure as in claim 6, wherein the shade unit is made of a heat dissipating material and, after the electrical unit is connected with the shade unit, the shade unit acts as a heat dissipating unit.
